(19) United States
(12) Patent Application Publication
(10) Pub. No.: US 2017/0107018 A1
(43) Pub. Date: Apr. 20, 2017

(54) ANIMAL WASTE BAGS WITH INDICATOR

(71) Applicant: Kimberley Anne Graham, Sherwood Park (CA)

(72) Inventor: Kimberley Anne Graham, Sherwood Park (CA)

(21) Appl. No.: 14/885,967

(22) Filed: Oct. 16, 2015

(51) Int. Cl. B65D 33/00; C08J 5/00; B65D 65/46; B65F 1/00; A01K 23/00; B65D 33/16

(52) U.S. Cl. CPC B65D 33/004; A01K 23/005; B65D 33/002; B65D 33/16; B65D 65/466; B65F 1/0006; C08J 5/00; B65F 2250/105; B65F 2240/136; C08J 2300/16

(57) ABSTRACT

A disposable animal waste bag comprising a roll of plastic bags, the roll comprising: a) a plurality of tubular plastic bags comprising an opening, a first edge, a second edge, a closed third edge, a first side and a second side, comprising i. a plurality of starting bags, and ii. a plurality of final bags; and b) an indicator system comprising the plurality of final bags, wherein the indicator system indicates that the roll has only has the plurality of final bags remaining in the roll and that a new roll is needed.

### FIELD OF THE INVENTION

The present disclosure is in the field of an apparatus for picking up and disposing of animal waste, including a dog's bowel movements.

### BACKGROUND OF THE DISCLOSURE

With laws and ordinances and Homeowners' Association rules and bylaws, pet owners are responsible for cleaning up animal fecal waste. The cleanup after one's pet is inconvenient and requires a type of “animal waste bag” for convenience and to prevent human contact with animal feces. The process of collecting pet excrement can be uncomfortable and unsanitary. This discomfort can be exaggerated during the use of animal waste bags when pet owners, property managers, etc. realize that the roll of animal waste bags is empty.

It would be beneficial to provide a disposable animal waste bag such that, when the roll is nearing the end and there are only a limited number of bags remaining in the roll that the roll itself would provide an indicator to alert the user that a new roll is needed.

### SUMMARY OF THE INVENTION

A disposable animal waste bag comprising a roll of plastic bags, the roll comprising: a) a plurality of tubular plastic bags comprising an opening, a first edge, a second edge, a closed third edge, a first side and a second side, comprising i. a plurality of starting bags, and ii. a plurality of final bags; and b) an indicator system comprising the plurality of final bags, wherein the indicator system indicates that the roll has only has the plurality of final bags remaining in the roll and that a new roll is needed.

### BRIEF DESCRIPTION OF THE DRAWINGS

FIG. 1A is a side view of a roll of disposable animal waste bags 100 comprising a plurality of starting bags 104 and a plurality of final bags 102.

FIG. 1B is a top view of an illustration of an indicator system 200 comprising a variety of bags of different shapes.

FIG. 2 is a top view of an illustration of an indicator system 300 comprising a plurality of final bags 102.

FIG. 3 is a top view of a roll of an opening 402 of a disposable animal waste bag 400.

### DETAILED DESCRIPTION OF THE EMBODIMENTS

The following is a detailed description of certain specific embodiments of the disposable animal waste bag disclosed herein. In this description reference is made to the drawings.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

### Introduction

In one aspect, disclosed herein is a disposable animal waste bag comprising a roll of plastic bags, the roll comprising: a) a plurality of tubular plastic bags comprising an opening 110, a first edge 112, a second edge 114, a closed third edge 116, a first side 118 and a second side 120, comprising i. a plurality of starting bags, and ii. a plurality of final bags; and b) an indicator system comprising the plurality of final bags, wherein the indicator system indicates that the roll has only has the plurality of final bags remaining in the roll and that a new roll is needed, wherein the plurality of tubular plastic bags of the roll are folded between the first edge and the second edge, gusseted along the first edge and the second edge or a combination thereof, wherein the plurality of final bags are visually different from the plurality of starting bags.

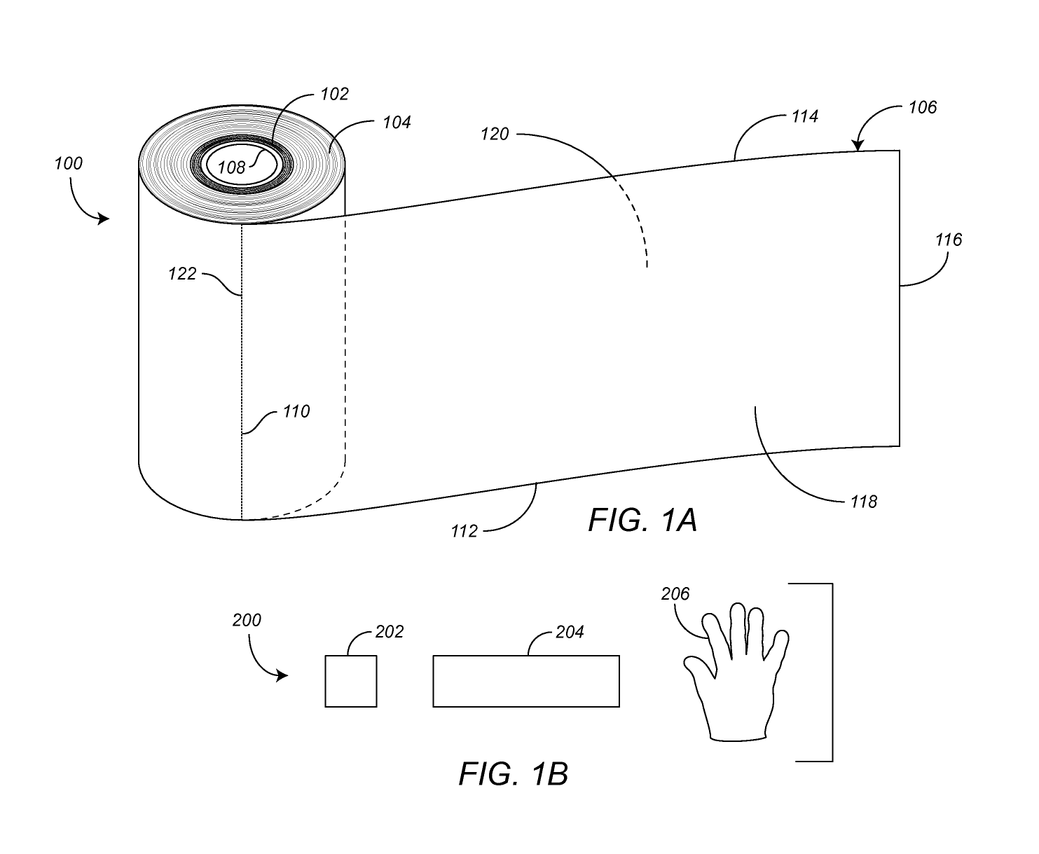

Referring to the drawings, FIG. 1A is an illustration of a roll of disposable animal waste bags 100 comprising a roll of plastic bags according to the present disclosure including a first bag 106. The roll of bags 100 comprises a roll of a plurality of starting bags 104 and a plurality of final bags 102. FIG. 1B depicts and illustration of disposable animal waste bags 200, comprised of bags of a variety of shapes. In some embodiments, the first side and the second side of the bag are a square shape 202, rectangular shape 204, hand shape 206 or an irregular shape. In some embodiments, the first side and the second side of the bag have a length of between about 6 inches to about 18 inches and a width of between about 6 inches to about 12 inches.

In some aspects the roll of disposable animal waste bags 100 comprise an inner core 108, whereby the roll of disposable animal waste bags 100 is rolled around the inner core 108 during a production process. In some embodiments, the inner core 108 is absent with the roll of disposable animal waste bags 100.

In some embodiments, the third edge comprises a plurality of perforation lines 122 extending along the first side which correspond to a plurality of perforation lines along the second side of the plastic film, wherein adjacent bags are capable of being separated from each other. In some embodiments, the perforation lines comprise a sinusoidal pattern, a repeating square shape, a repeating triangular shape, a repeating saw tooth shape or a combination thereof. In some embodiments, the perforation lines extend in substantially straight lines from the first edge of the first side to the second side of the animal waste bag.

The disposable animal waste bags of the present disclosure comprise an indicator system to alert a user that the roll of bags is nearly empty. Moreover, the indicator system comprising a number of final bags that are known by the user prior to using the roll. Therefore, the user would understand that once the first final bag is used that there are known number of final bags remaining in the roll. Therefore, the user would be aware that a specific number of final bags remain in the roll and that it is time to have a new roll of disposable animal waste bags.

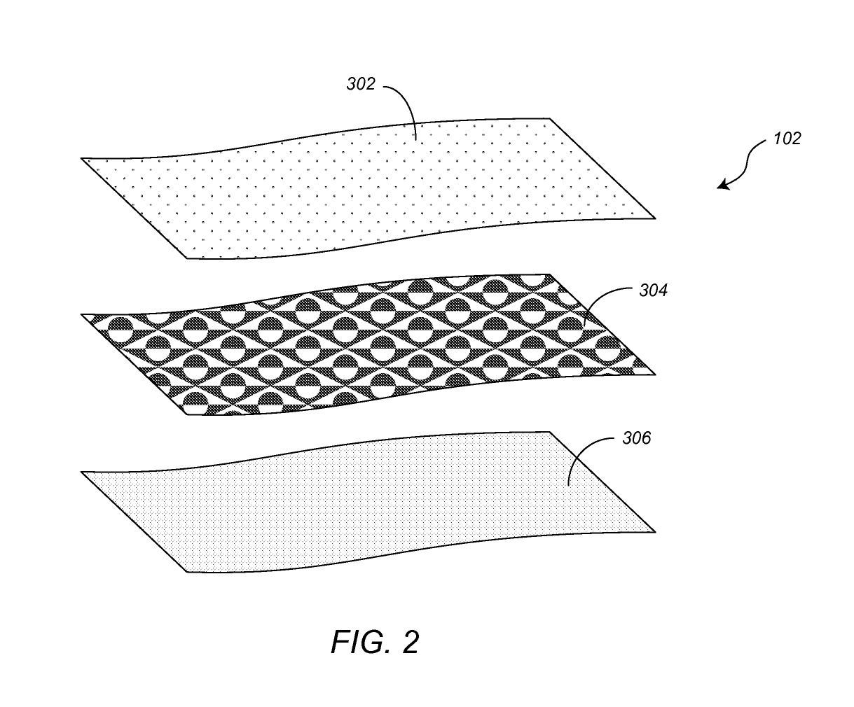

Referring to the drawings, FIG. 2, the plurality of final bags comprise alternating solid colors and/or color patterns 302, colored shapes 304, texture 306 or a combination thereof, wherein the plurality of final bags are visually different from the plurality of starting bags. Furthermore, FIG. 2 illustrates a a plurality of final bags 102. In some embodiments, the number of final bags 102 of between about 2 to about 12 final bags that are visually different than the starting bags 104, which alerts the user who is aware of the number of final bags 102 of the roll of disposable animal waste bags 100. In some embodiments, the plurality of final bags is 3 final bags 102 that are visually different from the plurality of starting bags 104.

A number of different types of plastic can be used to form the roll of disposable animal waste bags 100 includes, for example, polypropylene (PP), polyethylene (PE), metallocene-polyethylene (mPE), low density polyethylene (LDPE), linear low density polyethylene (LLDPE), ultra low density polyethylene (ULDPE), biaxially-oriented polyethylene terephthalate (BPET), high density polyethylene (HDPE), polyethylene terephthalate (PET), among other polyolefin plastomers and combinations and blends thereof. Still other materials that may be used include styrenic block copolymers, polyolefin blends, elastomeric alloys, thermoplastic polyurethanes, thermoplastic copolyesters, thermoplastic polyamides, polymers and copolymers of polyvinyl chloride (PVC), polyvinylidene chloride (PVDC), saran polymers, ethylene/vinyl acetate copolymers, cellulose acetates, polyethylene terephthalate (PET), ionomer, polystyrene, polycarbonates, styrene acryloacrylonitrile, aromatic polyesters, linear polyesters, and thermoplastic polyvinyl alcohols. In some embodiments, the animal waste bag is constructed from a biodegradable plastic. In some embodiments, the biodegradable plastic is derived from polybutylene adipate co-terephthalate (PBAT), thermoplastic starch, cellulose esters polyhydroxyalkanoates (PHAs), polybutylene adipate co-succinate co-terephthalate (PBAST), polyvinyl alcohol (PVOH), polybutylene succinate (PBS), poly-3-hydroxybutyrate (PHB), polyhydroxyvalerate (PHV) and polyhydroxyhexanoate (PHH), polylactic acid (PLA), polyglycolic acid, polyesters, polyurethanes, Polyamide 11, Polyamide 410 or a combination thereof Moreover, the animal waste bag may be constructed from compostable or biodegradable materials. Those skilled in the art will recognize that a wide variety of other plastic materials may also be used.

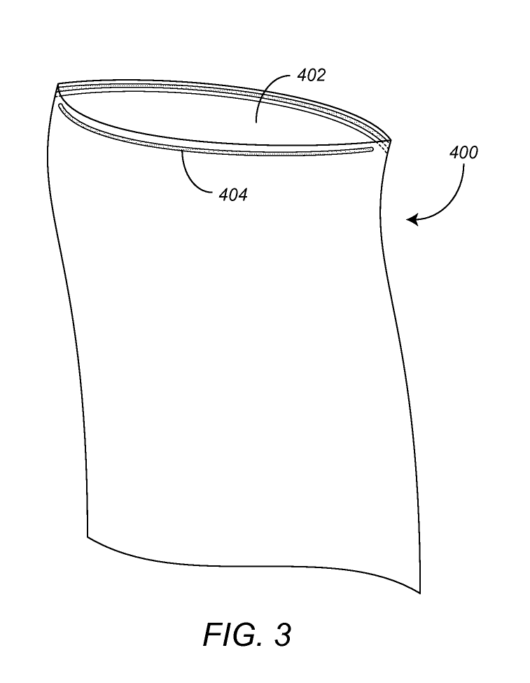

Referring to the drawings, FIG. 3 illustrates a disposable animal waste bag 400 comprising a sealing closure 404. In some embodiments, the disposable animal waste bag comprises a plurality of sealing closures, wherein the plurality of the sealing closures are adjacent to the opening 110. The sealing closure mechanisms provide a resealable closure for the opening bags. Such sealing closure mechanisms are well known in the art, and include those sold under the ZIPLOC® trademark by the assignee of the subject application. Often these sealing closure mechanisms include a pair of interlocking members.

The presently disclosed disposable animal waste bag is not to be limited in scope by the specific embodiments described herein, which are intended as single illustrations of individual aspects of the presently disclosed devices and methods, and functionally equivalent devices, methods and components are within the scope of the presently disclosed disposable animal waste bag. Indeed, various modifications of the presently disclosed disposable animal waste bag, in addition to those shown and described herein will become apparent to those skilled in the art from the foregoing description and accompanying drawings. Such modifications are intended to fall within the scope of the appended claims.

What is claimed is:

1. A disposable animal waste bag comprising a roll of plastic bags, the roll comprising:
a) a plurality of tubular plastic bags comprising an opening, a first edge, a second edge, a closed third edge, a first side and a second side, comprising
i. a plurality of starting bags, and
ii. a plurality of final bags; and
b) an indicator system comprising the plurality of final bags, wherein the indicator system indicates that the roll has only has the plurality of final bags remaining in the roll and that a new roll is needed.

2. The disposable animal waste bag of claim 1, wherein the animal is a dog.

3. The disposable animal waste bag of claim 1, wherein the plurality of tubular plastic bags of the roll are folded therebetween the first edge and the second edge, gusseted along the first edge and the second edge or a combination thereof.

4. The disposable animal waste bag of claim 1, wherein the plurality of final bags are visually different from the plurality of starting bags.

5. The disposable animal waste bag of claim 1, wherein the plurality of final bags comprise 2 to 10 final bags that are visually different from the plurality of starting bags.

6. The disposable animal waste bag of claim 1, wherein the plurality of final bags comprise alternating solid colors, color patterns, colored shapes, texture or a combination thereof, wherein the plurality of final bags are visually different from the plurality of starting bags.

7. The disposable animal waste bag of claim 1, wherein the third edge comprises a plurality of perforation lines extending along the first side which correspond to a plurality of perforation lines along the second side of the plastic film, wherein adjacent bags are capable of being separated from each other.

8. The disposable animal waste bag of claim 7, wherein the perforation lines comprise a sinusoidal pattern, a repeating square shape, a repeating triangular shape, a repeating saw tooth shape or a combination thereof

9. The disposable animal waste bag of claim 7, wherein the perforation lines extend in substantially straight lines from the first edge of the tubular plastic film to the second edge of the tubular plastic film.

10. The disposable animal waste bag of claim 1, further comprising a plurality of sealing closures, wherein the plurality of the sealing closures are adjacent to the perforation lines of the plastic film.

11. The disposable animal waste bag of claim 1, wherein the disposable animal waste bag is constructed from a plastic.

12. The disposable animal waste bag of claim 11, wherein the plastic comprises polypropylene (PP), polyethylene (PE), metallocene-polyethylene (mPE), low density polyethylene (LDPE), linear low density polyethylene (LLDPE), ultra low density polyethylene (ULDPE), biaxially-oriented polyethylene terephthalate (BPET), high density polyethylene (HDPE), polyethylene terephthalate (PET) or a combination thereof.

13. The disposable animal waste bag of claim 1, wherein the disposable animal waste bag is constructed from a biodegradable plastic.

14. The disposable animal waste bag of claim 13, wherein the biodegradable plastic is derived from polybutylene adipate co-terephthalate (PBAT), thermoplastic starch, cellulose esters polyhydroxyalkanoates (PHAs), polybutylene adipate co-succinate co-terephthalate (PBAST), polyvinyl alcohol (PVOH), polybutylene succinate (PBS), poly-3-hydroxybutyrate (PHB), polyhydroxyvalerate (PHV) and polyhydroxyhexanoate (PHH), polylactic acid (PLA), polyglycolic acid, polyesters, polyurethanes, Polyamide 11, Polyamide 410 or a combination thereof

15. The disposable animal waste bag of claim 1, wherein the first side and the second side of the bag are a square shape, rectangular shape, hand shape or an irregular shape.

16. The disposable animal waste bag of claim 1, wherein the first side and the second side of the bag have a length of between about 6 inches to about 18 inches and a width of between about 6 inches to about 12 inches.
